(19) United States
(12) Patent Application Publication
(10) Pub. No.: US 2007/0069711 A1
(43) Pub. Date: Mar. 29, 2007

(54) DIODE STACK HIGH VOLTAGE REGULATOR

(75) Inventors: Oleg Dadashev, Hadera (IL); Alexander Kushnarenko, Haifa (IL)

Correspondence Address: Eitan Law Group;C/O LandonIP Inc., 1700 Diagonal Road, Suite 450, Alexandria, VA, 22314, US

(73) Assignee: Saifun Semiconductors, Ltd., Netanya (IL)

(21) Appl. No.: 11/236,359

(22) Filed: Sep. 27, 2005

(51) Int. Cl. G05F 3/16

(52) U.S. Cl. 323/315

(57) ABSTRACT

A high voltage regulator including a current mirror including a pair of transistors, one of the transistors being connected to a node that outputs an output voltage Vₒᵤₜ, a diode stack that includes a plurality of serially connected transistors T₀, T₁, T₂, . . . Tₙ, wherein the transistor T₁ is connected to a node n₀, to which is connected another transistor T₀ that receives an input bias voltage V_{bias}, and wherein a feedback voltage fb from node n₀ is fed to an input of the differential amplifier, the differential amplifier receiving an input reference voltage V_{ref} at one of its other inputs, and is also connected to positive voltage supply Vdd, the differential amplifier outputting to an NMOS transistor M, and wherein the high voltage regulator has a large diode stack gain and lower G_{DA}*G_{NMOS}*m, resulting in a generally constant feedback (loop) gain Gₗₒₒₚ wherein the loop gain is given by:
Loop Gain=Gₗₒₒₚ=G_{stack}*G_{DA}*G_{NMOS}*m
wherein m is the ratio of the two currents I₁ and I₂, that is, I₂=mI₁, G_{stack} is the gain of the diode stack, G_{DA} is the gain of the differential amplifier and G_{NMOS} is the gain of the NMOS transistor M.

### FIELD OF THE INVENTION

The present invention relates generally to voltage regulators, and particularly to a high voltage regulator with a diode stack instead of a divider, e.g., a resistor or capacitor divider.

### BACKGROUND OF THE INVENTION

Non-volatile memory (NVM) arrays, such as erasable, programmable read only memory (EPROM) or flash memory arrays, or electrically erasable, programmable read only memory (EEPROM) arrays, require high positive or negative voltages to program and erase memory cells of the array.

Read and write operations are typically carried out with voltages that are regulated above a positive voltage supply Vdd. The circuitry that supplies and controls the programming and verification voltages generally comprises a high voltage regulator or high voltage pump (the terms being used herein interchangeably). A typical high voltage regulator architecture is shown in FIG. 1.

A current mirror including a pair of PMOS (p-channel metal oxide semiconductor) transistors 4 and 5 have their gates connected to each other and their sources connected to a high voltage supply Vₕᵥ_{_{—}}_{supply}. The gate of transistor 4 is connected to its drain. The current through transistor 4 is I₁ and the current through transistor 5 is I₂. The drain of transistor 5 is connected via a node n to Vₒᵤₜ and to a divider 6 comprising a pair of serially connected circuit elements B₁ and B₂, e.g., resistors, diodes or capacitors. Divider 6 passes a feedback voltage fb to one of the inputs of a voltage amplifier (also called a differential stage or differential amplifier) 7. Differential amplifier 7 receives an input reference voltage V_{ref} at one of its other inputs, and is also connected to positive voltage supply Vdd. The output of differential amplifier 7 may be connected to the gate of an NMOS (n-channel metal oxide semiconductor) transistor M. The drain of transistor M is connected to the drain of transistor 4, and the source of transistor M is connected to ground.

The open loop gain (Gₗₒₒₚ) of the high voltage regulator of FIG. 1 (i.e., the ratio of the output voltage to the differential input voltage without any external feedback) is given by:
Loop Gain=Gₗₒₒₚ=G_{divider}*G_{DA}*G_{NMOS}*m

wherein m is the ratio of the two currents I₁ and I₂, that is, I₂=mI₁

The feedback voltage V_{fb} is approximately equal to the reference voltage V_{ref} (V_{fb}≈V_{ref})

In the case of divider 6 comprising a pair of serially connected resistors, the following relations hold:
ΔV_{fb}=G_{divider}*ΔVₒᵤₜ=(R_{B1}+R_{B2})/R_{B2}*ΔVₒᵤₜ
Vₒᵤₜ=(R_{B1}+R_{B2})/R_{B2}*V_{fb} ≈(R_{B1}+R_{B2})/R_{B2}*V_{ref}

There is an inherent stability problem with the prior art voltage regulator of FIG. 1, because a high loop gain (although having a fast recovery time) leads to instability of the regulator. On the other hand, a low loop gain results in a slow recovery time. In the case of a resistor divider, there may be a problem of parasitic capacitance to ground of the resistors, leading to another stability/recovery time problem. An additional capacitor divider problem is that of parasitic capacitance to ground which adversely affects the accuracy of Vₒᵤₜ. An additional diode divider problem is that it is not possible to have an arbitrary Vₒᵤₜ without significantly changing I₂.

### SUMMARY OF THE INVENTION

The present invention seeks to provide a novel high voltage regulator with a diode stack, as is described more in detail hereinbelow. The present invention may have a large diode stack gain (=1) but lower G_{DA}*G_{NMOS}*m, resulting in a generally constant feedback (loop) gain Gₗₒₒₚ. The invention has lower feedback delay, better stability and faster recovery time than the prior art.

There is thus provided in accordance with an embodiment of the present invention circuitry including a voltage regulator including a current mirror including a pair of transistors, one of the transistors being connected to a node that outputs an output voltage Vₒᵤₜ, a diode stack that includes a plurality of serially connected transistors T₀, T₁, T₂, . . . Tₙ, wherein the transistor T₁ is connected to a node n₀, to which is connected another transistor T₀ that receives an input bias voltage V_{bias}, and wherein a feedback voltage fb from node n₀ is fed to an input of the differential amplifier, the differential amplifier receiving an input reference voltage V_{ref} at one of its other inputs, and is also connected to positive voltage supply Vdd, the differential amplifier outputting to an NMOS transistor M, and wherein the high voltage regulator has a large diode stack gain and lower G_{DA}*G_{NMOS}*m, resulting in a generally constant feedback (loop) gain Gₗₒₒₚ, wherein the loop gain is given by:
Loop Gain=Gₗₒₒₚ=G_{stack}*G_{DA}*G_{NMOS}*m

wherein m is the ratio of the two currents I₁ and I₂, that is, I₂=mI₁, G_{stack} is the gain of the diode stack, G_{DA} is the gain of the differential amplifier and G_{NMOS} is the gain of the NMOS transistor M.

In accordance with an embodiment of the present invention ΔV_{fb}=G_{stack}*ΔVₒᵤₜ.

Further in accordance with an embodiment of the present invention Vₒᵤₜ=V_{fb}+n*V_{bias} ≈V_{ref}+n*V_{bias}, and G_{stack}≈1. The gates of the transistors of the current mirror may be connected to each other and their sources may be connected to a high voltage supply The serially connected transistors may include NMOS transistors. The transistors of the current mirror may include PMOS transistors

There is also provided in accordance with an embodiment of the present invention a high voltage regulator including a current mirror including a pair of PMOS transistors that have their gates connected to each other and their sources connected to a high voltage supply, wherein current through one of the PMOS transistors is I₁ and the current through the other PMOS transistor is I₂, wherein the current I₁ flows to a drain of an NMOS transistor M whose gate is connected to an output of a differential amplifier, wherein gates of the PMOS transistors of the current mirror are connected to each other and their sources are connected to a high voltage supply, and wherein the current I₂ flows to a diode stack that includes a plurality of serially connected NMOS transistors T₀, T₁, T₂, . . . Tₙ, wherein a drain of transistor Tₙ is connected to a drain of the PMOS transistor through which flows current I₂, and wherein a gate of transistor Tₙ is connected to its drain and a source of transistor Tₙ is connected to its bulk and to a drain of adjacent NMOS transistor Tₙ₋₁, and wherein a source of NMOS transistor T₁ is connected to a node n₀, which is connected to a drain of NMOS transistor T₀, wherein a gate of NMOS transistor T₀ receives an input bias voltage V_{bias} and a source of NMOS transistor T₀ is connected to its bulk and to ground, and wherein a feedback voltage from node n₀ is fed to an input of the differential amplifier, the differential amplifier receiving an input reference voltage V_{ref} at one of its other inputs, and is also connected to positive voltage supply Vdd, wherein the feedback voltage is approximately equal to the reference voltage V_{ref} and a gate-source voltage of the diode stack is approximately equal to the bias voltage, and wherein the high voltage regulator may has a large diode stack gain but lower G_{DA}*G_{NMOS}*m, resulting in a generally constant feedback (loop) gain Gₗₒₒₚ, wherein the loop gain is given by:
Loop Gain=Gₗₒₒₚ=G_{stack}*G_{DA}*G_{NMOS}*m
wherein m is the ratio of the two currents I₁ and I₂, that is, I₂=mI₁
ΔV_{fb}=G_{stack}*ΔVₒᵤₜ and
Vₒᵤₜ=V_{fb} +n*V_{bias}≈V_{ref}+n*V_{bias}. (G_{stack} may be approximately equal to 1)

### BRIEF DESCRIPTION OF THE DRAWINGS

The present invention will be understood and appreciated more fully from the following detailed description taken in conjunction with the drawings in which:

FIG. 1 is a simplified block diagram of a typical prior art high voltage regulator architecture; and

FIG. 2 is a simplified block diagram of a high voltage regulator architecture, in accordance with an embodiment of the present invention.

### DETAILED DESCRIPTION OF EMBODIMENTS

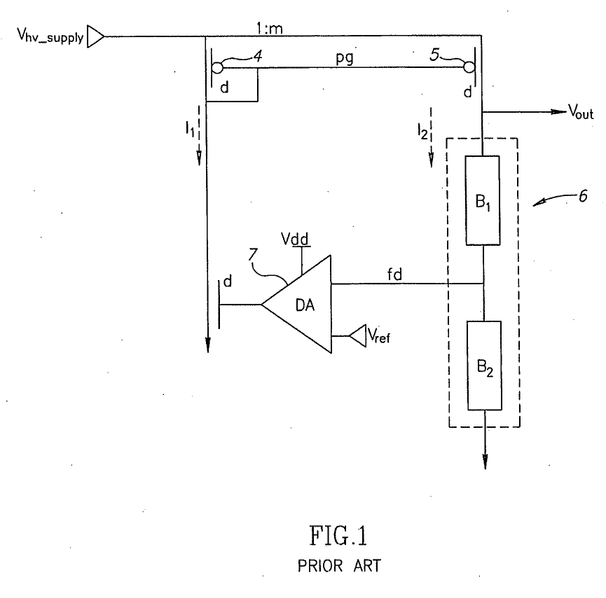

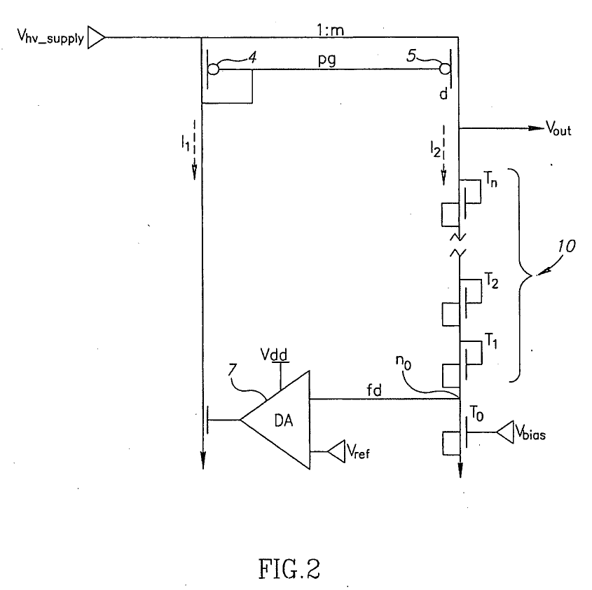

Reference is now made to FIG. 2, which illustrates a simplified block diagram of a high voltage regulator, in accordance with an embodiment of the present invention. Components of the circuitry of FIG. 2 that are similar to that of FIG. 1 are designated with the same reference labels, and the description is not repeated for the sake of brevity.

The divider 6 of the architecture of FIG. 1 is replaced in the non-limiting embodiment of FIG. 2 with a diode stack 10. Diode stack 10 may include a plurality of serially connected NMOS transistors T₀, T₁, T₂, . . . Tₙ. The drain of transistor Tₙ is connected to the drain of PMOS transistor 5. The gate of transistor Tₙ is connected to its drain. The source of transistor Tₙ is connected to its bulk and to the drain of the next NMOS transistor Tₙ₋₁. The source of transistor T₁ is connected to node n₀. The drain of another NMOS transistor T₀ is connected to node n₀. The gate of transistor T₀ receives an input V_{bias}. The source of transistor T₀ is connected to its bulk and to ground.

In the high voltage regulator of the present invention, as with the prior art, the open loop gain (Gₗₒₒₚ) is again given by:
Loop Gain=Gₗₒₒₚ=G_{stack}*G_{DA}*G_{NMOS}*m

wherein m is the ratio of the two currents I₁ and I₂, that is, I₂=mI₁

The gate-source voltage of the diode stack 10 (V_{gs}) is approximately equal to the bias voltage V_{bias} (V_{gs}≈V_{bias}). As with the prior art, The feedback voltage V_{fb} is approximately equal to the reference voltage V_{ref} (V_{fb}≈V_{ref}).

The high voltage regulator may have a large diode stack gain (=1) but lower G_{DA}*G_{NMOS}*m, resulting in a generally constant feedback (loop) gain Gₗₒₒₚ.
ΔV_{fb}=G_{stack}*ΔVₒᵤₜ (wherein G_{stack}=1)
Vₒᵤₜ =V_{fb}+n*V_{bias}≈V_{ref}+n*V_{bias}

It will be appreciated by person skilled in the art, that the present invention is not limited by what has been particularly shown and described herein above. Rather the scope of the present invention is defined only by the claims that follow:

What is claimed is:

1. A high voltage regulator comprising:
a current mirror comprising a pair of transistors, one of the transistors being connected to a node that outputs an output voltage Vₒᵤₜ;
a diode stack that comprises a plurality of serially connected transistors T₀, T₁, T₂, . . . Tₙ, wherein said transistor T₁ is connected to a node n₀, to which is connected another transistor T₀ that receives an input bias voltage V_{bias},
and wherein a feedback voltage fb from node n₀ is fed to an input of the differential amplifier, said differential amplifier receiving an input reference voltage V_{ref} at one of its other inputs, and is also connected to positive voltage supply Vdd, said differential amplifier outputting to an NMOS transistor M,
and wherein said high voltage regulator has a large diode stack gain and lower G_{DA}*G_{NMOS}*m, resulting in a generally constant feedback (loop) gain Gₗₒₒₚ, wherein said loop gain is given by:
Loop Gain=Gₗₒₒₚ=G_{stack}*G_{DA}*G_{NMOS}*m
wherein m is the ratio of the two currents I₁ and I₂, that is, I₂=mI₁, G_{stack} is the gain of said diode stack, G_{DA} is the gain of said differential amplifier and G_{NMOS} is the gain of said NMOS transistor M.

2. The high voltage regulator according to claim 1, wherein ΔV_{fb}=G_{stack}*ΔVₒᵤₜ.

3. The high voltage regulator according to claim 1, wherein Vₒᵤₜ=V_{fb}+n*V_{bias}≈V_{ref}+n*V_{bias}.

4. The high voltage regulator according to claim 1, wherein G_{stack}≈1.

5. The high voltage regulator according to claim 1, wherein gates of the transistors of the current mirror are connected to each other and their sources are connected to a high voltage supply.

6. The high voltage regulator according to claim 1, wherein the serially connected transistors comprise NMOS transistors.

7. The high voltage regulator according to claim 1, wherein the transistors of said current mirror comprise PMOS transistors.

8. A high voltage regulator comprising:
a current mirror comprising a pair of PMOS transistors that have their gates connected to each other and their sources connected to a high voltage supply, wherein current through one of the PMOS transistors is I₁ and the current through the other PMOS transistor is I₂, wherein the current I₁ flows to a drain of an NMOS transistor M whose gate is connected to an output of a differential amplifier;
wherein gates of the PMOS transistors of the current mirror are connected to each other and their sources are connected to a high voltage supply;
and wherein the current I₂ flows to a diode stack that comprises a plurality of serially connected NMOS transistors T₀, T₁, T₂, . . . Tₙ, wherein a drain of transistor Tₙ is connected to a drain of the PMOS transistor through which flows current I₂, and wherein a gate of transistor Tₙ is connected to its drain and a source of transistor Tₙ is connected to its bulk and to a drain of adjacent NMOS transistor Tₙ₋₁, and wherein a source of NMOS transistor T₁ is connected to a node n₀, which is connected to a drain of NMOS transistor T₀, wherein a gate of NMOS transistor T₀ receives an input bias voltage V_{bias} and a source of NMOS transistor T₀ is connected to its bulk and to ground,
and wherein a feedback voltage from node n₀ is fed to an input of the differential amplifier, said differential amplifier receiving an input reference voltage V_{ref} at one of its other inputs, and is also connected to positive voltage supply Vdd,
wherein said feedback voltage is approximately equal to the reference voltage V_{ref} and a gate-source voltage of said diode stack is approximately equal to said bias voltage,
and wherein said high voltage regulator may has a large diode stack gain but lower G_{DA}*G_{NMOS}*m, resulting in a generally constant feedback (loop) gain Gₗₒₒₚ, wherein said loop gain is given by:
Loop Gain=Gₗₒₒₚ=G_{stack}*G_{DA}*G_{NMOS}*m
wherein m is the ratio of the two currents I₁ and I₂, that is, I₂=mI₁
ΔV_{fb}=G_{stack}*ΔVₒᵤₜ and
Vₒᵤₜ=V_{fb}+n*V_{bias}≈V_{ref}+n*V_{bias}.

9. The high voltage regulator according to claim 8, wherein G_{stack}≈1.
